(19) United States
(12) Patent Application Publication
(10) Pub. No.: US 2008/0276370 A1
(43) Pub. Date: Nov. 13, 2008

(54) Trolley For Transporting a Patient and a Patient Handling System

(75) Inventors: Arthur Van Es, Eindhoven (NL); Ravindra Bhat, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,425

(22) PCT Filed: Oct. 24, 2006
(86) PCT No.: PCT/IB06/53902

§ 371 Date: May 2, 2008

(30) Foreign Application Priority Data
Nov. 2, 2005 (EP) 05110269.7

(51) Int. Cl. A61G 7/10; A61G 13/10

(52) U.S. Cl. 5/81.1 R

(57) ABSTRACT

A trolley for transporting a lying patient comprising a transferable table-top (8) for carrying the lying patient, which table-top (8) can be taken over by a stationary table-base. The trolley has free space below a main portion of the table-top (8), so that the table-top (8) can be located above the stationary table-base by moving the trolley towards the stationary table-base. The trolley comprises two end structures (1,2) each provided with rollers (6) for rolling over the floor, and an intermediate structure (3,4) connecting the two end structures (1,2). A main part of the intermediate structure (3,4) is located at a level near the table-top (8), so that the intermediate structure (3,4) can be moved over said stationary table-base.

The invention is related to a trolley for transporting a lying patient, comprising a transferable table-top for carrying the lying patient, which table-top can be taken over by a stationary table-base, i.e. the table-top is transferable from the trolley to the stationary table-base and vice versa, whereby the trolley has free space below a main portion of the table-top, so that the table-top can be located above the stationary table-base by moving the trolley towards the stationary table-base, whereby the trolley comprises two end structures each provided with rollers for rolling over the floor, and an intermediate structure connecting the two end structures.

A system for handling a patient in a hospital may comprise various elements, such as a trolley for transporting the patient and structures for supporting the patient during treatment or during examination of the body of the patient. In a preferred patient handling system, the patient lies on the same support plate during transport as well as during treatment or examination, so that there is no need to touch or displace the patient that is lying on the support plate. Thereby, the support plate, hereinafter called table-top, has to be transferred from the trolley to a stationary table-base, and vice versa, which table-base holds and/or moves the table-top in the desired positions during examination or during treatment of the body of the patient.

A medical system whereby a table-top can be carried by a trolley as well as by a stationary table-base, as described above, is disclosed in DE-A-19533098. Thereby, the trolley has an open space, so that it can be moved to a position whereby it surrounds the stationary table-base, whereby the stationary table-base is present in said open space. The stationary table-base belongs to a medical apparatus and the upper side of the table-base can be moved in upward direction, so that it engages the lower side of the table-top and lifts the table-top from the trolley. After the table-top is transferred to the stationary table-base, the table-base can move the table-top in the desired positions with respect to the other parts of the medical apparatus.

The Trolley comprises two end structures provided with rollers and an intermediate structure connecting the two end structures. When the trolley is moved to the stationary table-base in order to locate the table-top above the table-base, the two end structures are located at opposite transverse sides of the stationary table-base, while the intermediate structure is present at only one longitudinal side of the stationary table-base. Hereinafter, the short sides of a substantial rectangular object are indicated as transverse sides, and the long sides are indicated as longitudinal sides. Seen in top view, the two end structures and the intermediate structure of the trolley form a U, whereby the intermediate structure is the base of the U and the two end structures are the legs of the U. Thereby, the trolley has one open longitudinal side, so that the stationary table-base can pass that side in order to arrive in said free space underneath the table-top.

In such patient handling system, the trolley must always approach the stationary table-base with its open longitudinal side in front. Depending on the desired position of the patient on the stationary table-base, i.e. with the head of the patient in either one or the other direction, the trolley has to approach the stationary table-base from one or the other longitudinal side. In case it is only possible to approach the stationary table-base from only one longitudinal side, for example because of lack of space at the other longitudinal side, there is no choice to position the patient in one of the two positions on the table-base. In that case, the patient has to be placed in the predetermined position when he is laid on the table-top.

An object of the invention is a medical patient handling system, whereby a trolley for transporting a lying patient comprises a transferable table-top for carrying the patient, which table-top can be transferred from the trolley to the stationary table-base, whereby the table-top can be transferred to the stationary table-base with either one or the other direction, i.e. whereby the head of the patient can be located near opposite transverse sides of the stationary table-base, at the choice of the operating person.

To accomplish with the object, the intermediate structure is located at a level near the table-top, so that a main part of the intermediate structure can be moved over said stationary table-base. Thereby, the trolley can approach the stationary table-base with either longitudinal side in front, whereby the head of the patient can be located at either transverse side of the table-top, according to the choice of the operating person.

In a preferred embodiment, the distance between the floor and the central part of the intermediate structure, i.e. the part in the middle between the two end structures, is more than 50%, preferably more than 75%, and more preferably more than 85% of the distance between the floor and the table-top. Thereby, the intermediate structure can be moved over the stationary table-base, although the table-base has a relative large height, as is usual in a medical apparatus. Preferably, the table-top is supported by the two end structures of the trolley, and not by other parts of the trolley, whereby the table-top has to be sufficient stiff to carry the lying patient.

The table-top can be connected with the stationary table-base through a connection member that is present at the lower side of the table-top, which connection member engages a corresponding member at the upper side of the stationary table-base. In a preferred embodiment, the table-top is provided with two connection members for engaging the corresponding member of the stationary table-base, whereby both connection members are located at the lower side of the table-top. When the table-top is connected with the stationary table-base, only one connection member will engage the corresponding member of the stationary table-base, and the other connection member will be used when the table-top is connected with the table-base while it is positioned in opposite direction.

Preferably, a connection member is located near each end of the table-top, so that the table-top is engaged by the stationary table-base near one of its ends. Therefore, the table-top can be moved by the table-base into a positioned whereby a main portion of it is located away from the table-base. Such position may be desired when the body of the patient has to be placed in the examination space of, for example, a MRI scan.

After the table-top is transferred to the stationary table-base, the upper side of the table-base is lifted, whereby the intermediate structure of the trolley can not be moved over the stationary table-base. Therefore, the trolley cannot be moved away from the stationary table-base, unless the intermediate structure is present at only one longitudinal side of the stationary table-base, while there is no part of the trolley present at the opposite longitudinal side of the table-base. Therefore, in a preferred embodiment, the intermediate structure is present at one longitudinal side of the trolley, i.e. near only one longitudinal side of the table-top, when the table-top is present on the trolley. Thereby, the trolley can be moved away from the stationary table-base when the table-top is connected with the table-base.

In a preferred embodiment, the intermediate structure is provided with a protection frame at least located at one longitudinal side of the table-top when the table-top is present on the trolley, which protection frame can be moved downwardly. The protection frame protects the lying patient on the table-top, and furthermore, the operating person can engage the protection frame by hand in order to move the trolley.

The invention is furthermore related to a patient handling system comprising a trolley as described above and a stationary table-base, whereby the stationary table-base is provided with means for engaging the table-top and whereby said means can move in vertical direction, thereby lifting the table-top.

The invention will now be further elucidated by means of a description of two embodiments of a trolley for transporting a lying patient comprising a transferable table-top for carrying the lying patient, whereby reference is made to the drawing in which:

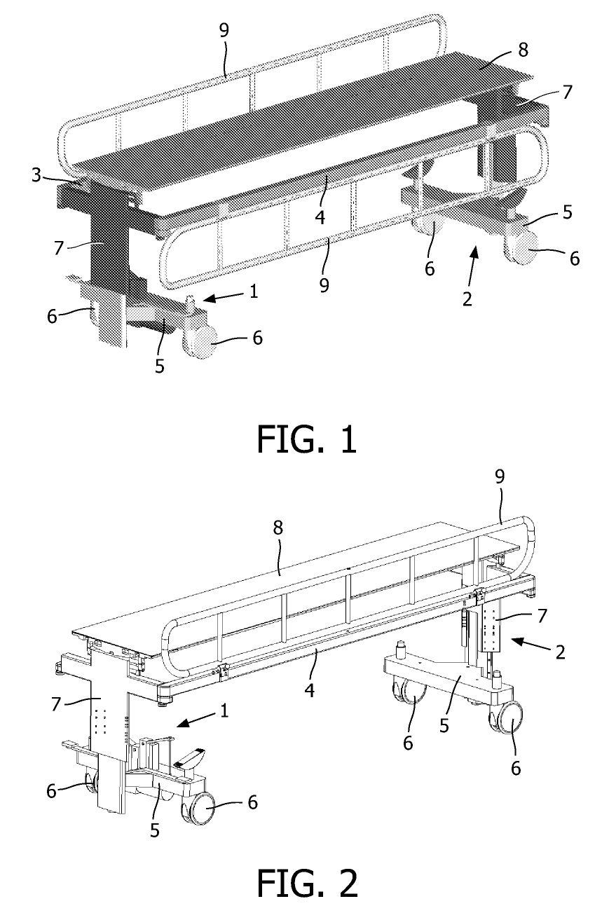

FIG. 1 is a perspective view of the first embodiment of a trolley;

FIG. 2 is a perspective view of the second embodiment;

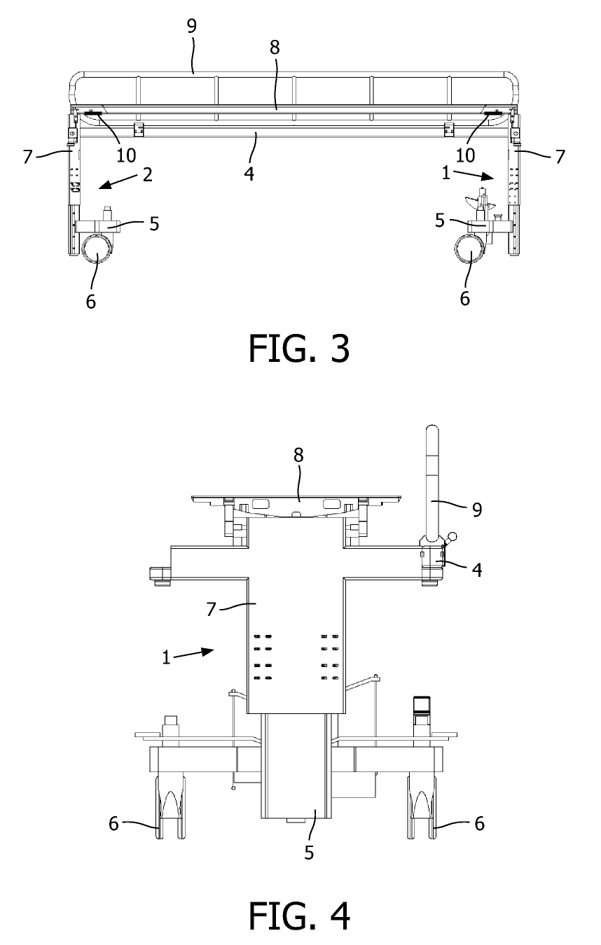

FIG. 3 is a side view of the second embodiment;

FIG. 4 is another side view of the second embodiment;

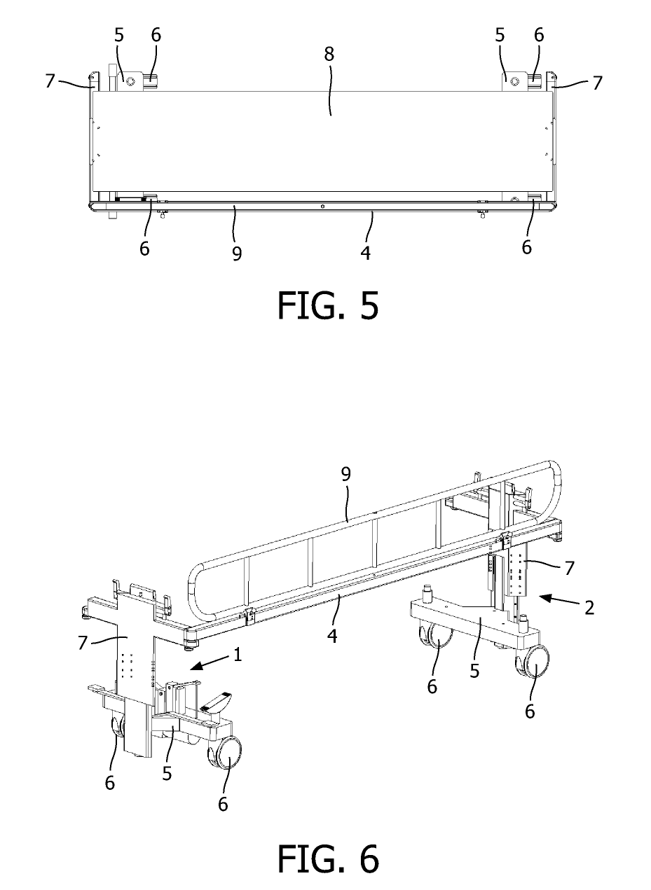

FIG. 5 is a top view of the second embodiment; and

FIG. 6 is a perspective view of the second embodiment without the table-top.

The figures are only diagrammatic representations, whereby only parts that are relevant for the elucidation of the invention are indicated.

FIG. 1 shows the first embodiment of the trolley comprising two end structures 1,2 at both opposite transverse sides of the trolley. Between the two end structures 1,2 is an intermediate structure consisting of two horizontal bars 3,4, one horizontal bar 3,4 at each longitudinal side of the trolley. Only a small portion of bar 3 is visible in the FIG. 1. The two end structures 1,2 and the intermediate structure 3,4 are firmly interconnected, so that a solid structure of the trolley is obtained.

Each end structure 1,2 comprises a lower part 5 provided with two rollers 6. The rollers 6 can pivot around a vertical axis, so that the operating person can move the trolley in any horizontal direction, whereby the rollers 6 are rolling on the floor. The upper part 7 of each end structure 1,2 is connected with the intermediate structure 3,4 and is also connected with an end of the table-top 8. The connection between the upper parts 7 of the two end structures 1,2 and the table-top 8 is detachable, so that a stationary table-base (not shown in the figures) can lift the table-top 8 from the trolley, when the stationary table-base is underneath the table-top 8. The table-top 8 can be placed back on the trolley by lowering the table-top 8 while the trolley is in the same position.

Each bar 3,4 of the intermediate structure is provided with a protection frame 9, which protection frame 9 can pivot around the respective bar 3,4 from an upward position into a downward position, as is shown in FIG. 1 for bar 4 at the front side of the trolley. The protection frame 9 of bar 3 is shown in its upward position. When both protection frames 9 are in the upward position, there is free space underneath the intermediate structure 3,4. Due to the relative large distance between the floor and the bars 3,4 of the intermediate structure, the trolley can be moved towards a stationary table-base, whereby the table-top 8 can be brought above the table-base. Thereby, one of the bars 3,4 is moved over the table-base.

In that position, the upper side of the table-base can be moved in upward direction and can engage the table-top 8. Then the table-top 8 can be lifted from the trolley by further moving the upper side of the table-base in upward direction. After the table-top 8 is lifted from the trolley, the trolley cannot be moved away, because the upper part of the table-base is raised and is present between the two bars 3,4 of the intermediate structure of the trolley.

FIGS. 2-6 show the second embodiment of a trolley, which trolley can be moved way from the table-base after the table-top is transferred to the table-base. The perspective view of the second embodiment in FIG. 2 is similar to the perspective view of the first embodiment in FIG. 1, and similar parts are indicated with the same referential numerals.

As indicated in FIG. 2, the second embodiment of the trolley comprises two end structures 1,2 and an intermediate structure connecting the two end structures 1,2. Thereby, the intermediate structure consists of a bar 4 at one longitudinal side of the trolley, in FIG. 2 the front side of the trolley. Because there is only one bar 4 (bar 3 is not present), there is also only one protection frame 9, located at one longitudinal side of the table-top 8.

FIGS. 3 and 4 are side views of the second embodiment of the trolley; FIG. 3 shows a longitudinal side in front and FIG. 4 shows a transverse side in front of the trolley. In FIG. 3 two connection members 10 are shown at the lower side of table-top 8, one connection member 10 near each end of the table-top 8. The upper side of the stationary table-base is provided with one corresponding member for engaging either one or the other connection member 10, depending of the position of the table-top 8 above the table-base.

FIG. 5 is a top view of the second embodiment of the trolley, and FIG. 6 shows the second embodiment of the trolley in a perspective view, whereby the table-top is removed.

The two embodiments of the trolley as described above are only examples of a trolley according to the invention; many other embodiments are possible.

1. A trolley for transporting a lying patient comprising a transferable table-top for carrying the lying patient, which table-top can be taken over by a stationary table-base, whereby the trolley has free space below a main portion of the table-top, so that the table-top can be located above the stationary table-base by moving the trolley towards the stationary table-base, the trolley further comprising two end structures each provided with rollers for rolling over a floor, and an intermediate structure connecting the two end structures, characterized in that a main part of the intermediate structure is located at a level near the table-top, so that the intermediate structure can be moved over said stationary table-base.

2. A trolley as claimed in claim 1, characterized in that the distance between the floor and a central portion of the intermediate structure, is more than 50%, preferably more than 75%, and more preferably more than 85% of the distance between the floor and the table-top.

3. A trolley as claimed in 1, characterized in that the table-top is supported by the two end structures of the trolley.

4. A trolley as claimed in claim 1, characterized in that the table-top is provided with two connection members for engaging a corresponding member of the stationary table-base, whereby both connection members are located at the lower side of the table-top.

5. A trolley as claimed in claim 4, characterized in that a connection member is located near each end of the table-top.

6. A trolley as claimed in 1, characterized in that the intermediate structure is present at only one longitudinal side of the trolley.

7. A trolley as claimed in claim 1, characterized in that the intermediate structure is provided with a protection frame at least located at one longitudinal side of the table-top, which protection frame can be moved downwardly.

8. A patient handling system comprising a trolley as claimed in claim 1 and a stationary table-base, characterized in that the stationary table-base is provided with means for engaging the table-top, whereby said means can move in vertical direction, thereby lifting the table-top.
